(19) United States
(12) Patent Application Publication
(10) Pub. No.: US 2014/0072498 A1
(43) Pub. Date: Mar. 13, 2014

(54) Manufacturing and Applications of Silicon Metal

(71) Applicant: Boston Silicon Materials, LLC, Belmont, MA (US)

(72) Inventor: Andrew Matheson, Belmont, MA (US)

(73) Assignee: Boston Silicon Materials, LLC, Belmont, MA (US)

(21) Appl. No.: 14/078,927

(22) Filed: Nov. 13, 2013

Related U.S. Application Data
(63) Continuation of application No. PCT/US2012/037740, filed on May 14, 2012.
(60) Provisional application No. 61/486,429, filed on May 16, 2011.

(51) Int. Cl. C01B 33/027

(52) U.S. Cl. CPC C01B 33/027
USPC 423/350; 204/298.13

(57) ABSTRACT

A method of manufacture is described that uses liquid phase reduction of silicon hydride, to produce silicon metal. Working in liquid phase permits a more compact plant design and offers significantly lower capital costs.

### CROSS-REFERENCE TO RELATED APPLICATIONS

This application is a continuation of commonly owned, copending PCT Application Ser. No. PCT/US2012/037740, filed May 14, 2012. The PCT Application claims priority from commonly owned, copending, U.S. Provisional Patent Application Ser. No. 61/486,429, filed May 16, 2011. The disclosures of these applications are hereby incorporated herein by reference.

### FIELD OF THE INVENTION

This invention relates to the production of high purity silicon metal.

### BACKGROUND OF THE INVENTION

Silicon metal is useful both as the basis for semiconductors, and as the key constituent of the majority of photovoltaic (PV) cells. Silicon metal for these applications is required to be extremely pure, typically 99.9999% (6N) or higher purity for PV cells, and typically 9N or higher purity for semiconductor applications. Silicon of this purity is usually manufactured in large and extremely capital-intensive facilities, in which gas phase chemical vapor deposition is used to build up high purity silicon metal from silicon-containing gases. The two main gases used are trichlorosilane (SiHCl₃), and silicon hydride or silane (SiH₄).

In this invention, a method of manufacture is described that uses liquid phase reduction of silicon hydride, to produce silicon metal. Working in liquid phase permits a more compact plant design and offers significantly lower capital costs.

### SUMMARY OF THE INVENTION

The invention relates to the production of silicon metal, for which the production process is particularly well-suited and also economically advantageous.

One preferred process of the present invention comprises:

introducing silane gas into a reactor vessel containing a reductant, preferentially an alkali or alkaline earth metal or combinations thereof, and most preferentially sodium metal, potassium metal, and alloys thereof, at a temperature sufficient to ensure the reductant is liquid;

separating the reaction product (a mixture of silicon metal and excess reductant) from the reductant in the reactor vessel;

heating the reaction product to a temperature to cause any reductant hydride to break down into reductant and hydrogen gas; and removing any excess reductant from the silicon metal.

The metal thus produced is in the form of a metal powder or extended aggregate structure with internal porosity.

The particle size produced by this process is controlled by a number of factors, including the reaction temperature, the relative concentrations of the reagents, and the melting point of silicon metal.

The metal produced by this methodology can be densified by melting to produce silicon of high purity. By controlling the purity of the silane and the reductant, silicon of a purity suitable for use in photovoltaic cells and even semiconductor devices can be produced.

Finally, all the processes described herein can be accomplished using a gas phase reductant in place of the preferred liquid phase reductant.

One embodiment of the present invention is a process to convert silane gas (SiH₄) to silicon metal by a liquid or vapor comprising reacting the silane gas with one or more alkali or alkaline earth metals. In certain preferred embodiments, the alkali or alkaline earth metals comprise either sodium, or potassium, or alloys thereof. In certain embodiments, the alkali or alkaline earth metal is captured and recovered for reuse in the process.

In certain embodiments, the reaction product of this process comprises silicon metal, and at least 0.1% metallic sodium. In certain embodiments, the reaction product of this process comprises silicon metal, and at least 1% metallic sodium. Yet another reaction product is hydrogen gas. The hydrogen generated in the process may be recovered and used in commercial applications, if desired.

In certain embodiments, the silicon metal, after removal of the excess sodium, has a purity of at least 99.9%. In certain embodiments, the silicon metal, after removal of the excess sodium, has a purity of at least 99.99%. In certain embodiments, the silicon metal, after removal of the excess sodium, has a purity of at least 99.999%. In certain embodiments, the silicon metal, after removal of the excess sodium, has a purity of at least 99.9999%. In certain embodiments, the silicon metal, after removal of the excess sodium, has a purity of at least 99.99999%. In certain embodiments, the silicon metal has a primary particle diameter of less than 1 micron.

Silicon metal having a purity as provided herein may be employed in a photovoltaic device. Silicon metal having a purity as provided herein may be employed in a semiconductor device. Silicon metal having a purity as provided herein may be employed in a sputtering target.

It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

It is to be understood that both the foregoing general description and the following detailed description are exemplary and explanatory only and are not restrictive of the invention as claimed. Other embodiments will be apparent to those skilled in the art from consideration of the specification and practice of the invention disclosed herein.

### DETAILED DESCRIPTION OF THE INVENTION

As described above, silane can be injected into molten reductant, and reduced therein to silicon metal in particulate form. The typical size of the silicon particle is a function of the temperature of the reaction, the flow rates of the reagents, and the diffusion characteristics of silicon. By careful control of the reaction conditions, one can select for a range of typical metal particle sizes. The surface area of the metal is related to the particle size, and the surface area of the metal particle determines many important physical characteristics of the metal in commercial applications. Particle sizes are summarized in the following table:

| | Reaction temperature, degrees Celsius | | |
|---|---|---|---|
| | 275 | 550 | 775 |
| Primary particle size, nm | 20-40 | 50-80 | 100-200 |
| Aggregate size, microns | 0.5-1 | 0.9-2 | 1-5 |

The reaction produces silicon powder incorporating a fraction of the reductant, and potentially also the hydride of the reductant. Hydrogen gas is also produced and in fact can be captured and used or sold. This reaction product can be removed from the reactor and then be treated to remove the reductant and any reductant hydride, or can first be treated before removing the silicon metal. There are many specific implementations of this technology, illustrated by the following representative but non-exhaustive examples.

### Example 1

Silane gas is injected into a reactor vessel containing molten sodium and is allowed to flow until the evolved hydrogen indicates the presence of unreacted silane gas, at which point the flow of silane is stopped.

The reactor vessel is then heated to a temperature of at least 300 degrees centigrade and a partial vacuum of 100 ton or less is applied to the vessel to remove any hydrogen produced by the breakdown of sodium hydride.

Once the remnant hydrogen has been removed, the temperature is raised to above the boiling point of sodium, and the sodium vapor is removed and condensed to recover the sodium. This step can be accomplished at lower temperatures by the application of a partial or full vacuum (100 torr or less) to the reactor vessel.

Finally, the silicon metal can be removed from the reactor vessel for further processing or sale, or else can be heated to above the melting point of silicon in order to produce a dense solid of silicon.

The sodium is not consumed in the reaction, instead acting as a catalyst to promote the decomposition of silane gas, and can be re-used with obvious beneficial impact on the economics of the process.

### Example 2

Silane gas is injected into a stream of sodium-potassium alloy (NaK) and decomposes to silicon, hydrogen, and potentially some hydrides of sodium and potassium.

The solid silicon is removed from the NaK stream by filtration. Hydrogen gas produced in the decomposition of silane is vented from the NaK stream and is recovered for disposal, sale or other use. The reactor products are captured without exposure to air or moisture.

The reaction products are then heated to break down any sodium or potassium hydrides into hydrogen and either sodium or potassium, and the hydrogen is captured for sale, use or disposal. This step can be facilitated by the application of a full or partial vacuum of 100 torr or less.

Next, the reaction product is heated to a temperature sufficient to remove as a vapor the NaK present with the silicon. Once again, a full or partial vacuum of 100 torr or less reduces the temperature required to remove the excess NaK.

Finally, the silicon metal can be taken for further processing or sale, or else can be heated to above the melting point of silicon in order to produce a dense solid of silicon.

The NaK is not consumed in the reaction, instead acting as a catalyst to promote the decomposition of silane gas, and can be re-used with obvious beneficial impact on the economics of the process.

### Example 3

In either of Examples 1 or 2 above, the removal of the sodium or the NaK can be achieved by use of a non-aqueous solvent (for example, ammonia, and alcohols such as methanol, ethanol etc, and other polar solvents) that does not dissolve the silicon metal.

The dissolved sodium or NaK can then be removed from the solvent for recycling, and the solvent can be recycled also. The silicon metal can then be recovered as described in Examples 1 and 2.

The above examples are intended only to be illustrative of the wide range of metals and alloys and their applications, made accessible by the invention described herein.

What is claimed is:

1. A process to convert silane gas to a reaction product comprising silicon metal by reaction with a liquid or vapor comprising one or more alkali or alkaline earth metal.

2. The process of claim 1 wherein the alkali or alkaline earth metals comprise either sodium, or potassium, or alloys thereof

3. The process of claim 2, wherein the reaction product comprises silicon metal and at least 0.1% metallic sodium.

4. The process of claim 2, wherein the reaction product comprises silicon metal and at least 1% metallic sodium.

5. The reaction product of claim 3, wherein after removal of the excess sodium, the silicon metal has a purity of at least 99.9%.

6. The reaction product claim 3, wherein after removal of the excess sodium, the silicon metal has a purity of at least 99.99%.

7. The reaction product of claim 3, wherein after removal of the excess sodium, the silicon metal has a purity of at least 99.999%.

8. The reaction product of claim 3, wherein after removal of the excess sodium, the silicon metal has a purity of at least 99.9999%.

9. The reaction product of claim 3, wherein after removal of the excess sodium, the silicon metal has a purity of at least 99.99999%.

10. The reaction product of claim 3, wherein the silicon metal has a primary particle size of 100 to 200 nm.

11. The reaction product of claim 3, wherein the silicon metal has a primary particle size of 50 to 80 nm.

12. The reaction product of claim 3, wherein the silicon metal has a primary particle size of 20 to 40 nm.

13. The process of claim 2, in which the alkali or alkaline earth metal is captured and recovered for reuse in the process.

14. The process of claim 2, wherein hydrogen is generated in the process and the hydrogen is captured for further use.

15. A photovoltaic device produced from the silicon metal of claim 5.

16. A semiconductor device produced from the silicon metal of claim 5.

17. A sputtering target produced from the silicon metal of claim 5.
